(19) United States
(12) Patent Application Publication
(10) Pub. No.: US 2006/0169324 A1
(43) Pub. Date: Aug. 3, 2006

(54) Antitampering ball valve

(76) Inventor: Renzo Cimberio, San Maurizio d'Opaglio (NO) (IT)

Correspondence Address: YOUNG & THOMPSON, 745 SOUTH 23RD STREET, 2ND FLOOR, ARLINGTON, VA, 22202, US

(21) Appl. No.: 10/548,096

(22) PCT Filed: Mar. 5, 2004
(86) PCT No.: PCT/EP04/02304

§ 371 Date: Sep. 6, 2005

(30) Foreign Application Priority Data
Mar. 6, 2003 (IT) MI2003A000412

(51) Int. Cl. F16K 35/00

(52) U.S. Cl. 137/385

(57) ABSTRACT

An antitampering and safety ball valve (1) in which, in the cylindrical seat (22) of the handle (20), for example of squared shape (20), for housing the nut to be threaded on the rod (8) for fixing the handle (20) on the valve (1), a nut (31) having an odd side number, preferably with a heptagonal shape, is used. A tubular wrench (33) with a recessed seat (34), having likewise a polygonal configuration with an odd number of sides and which can be housed, preferably with a small clearance, in the cylindrical seat (22) of the handle (20) being moreover provided.

### BACKGROUND OF THE INVENTION

The present invention relates to an antitampering ball valve according to the preamble of claim 1.

Conventional ball valves comprise a driving handle for rotatively driving the ball shutter of the valve, which handle can be constituted by a lever handle, a throttle handle, a wheel or squared handle, a squared handle, in particular, being shown in FIGS. 1-5. All the above prior handles comprise a contoured seat or recess for coupling, by a geometrical type of connection, to a like contoured portion provided on a threaded end portion of the rod projecting from the valve body, said handles being conventionally clamped or fixed on the valve body by threading a nut on the projecting threaded portion of the rod.

In the lever, throttle or wheel shape lever handles, the clamping nut for clamping said handles freely projects therefrom and, accordingly, it is freely accessible, and, accordingly, it can be easily removed by unauthorized persons, for example by using a wrench, a gripper or the like. In the squared handles, provided for engagement with a wrench, comprise, inside their squared portion, a circular cylindrical seat or recess for housing the clamping nut provided for clamping the handle on the rod. Also in this case, an unauthorized removal of the clamping nut can be easily obtained, both by using a conventional tubular wrench and by using, in an unauthorized manner, screw driver or blade elements, to be pressed against two parallel sides of the clamping nut, inside said circular seat or recess.

To prevent a ball valve, mounted, for example, on an utility system, such as a gas or water system, from being undesirably opened or closed, and for also preventing the valve handle from being removed and the valve from being disassembled, or for preventing any vandalic deformation thereof, i.e. for providing antitampering and safety valves, several solutions (U.S. Pat. No. 5,094,265. U.S. Pat. Nos. 5,797,285, 2,092,572, U.S. Pat. No. 4,716,922), also providing squared handle (WO 99/3142) are known, in which are included safety components in a cap or the like configuration, cooperating with lock, pin and padlock elements. The above solutions, in addition to requiring additional safety components, also requires additional machining operations and assembling steps, with a consequent increase of their making cost.

The above mentioned antitampering valves are mainly used by water and gas utility companies, for switching off the water or gas supply to defaulting users.

However, in actual practice, for ball valves installed in outside environments, and provided, for example, with a throttle rotary, lever or wheel handle, it would be likewise desirable to make said valves with a safety construction for preventing an easy removal of their driving handle and unauthorized closure/opening operations thereof, where, for said outside environment all valves, the provision of prior safety components including cap elements with inner locks or padlocks and the like, would involve an excessive increase of their cost.

### SUMMARY OF THE INVENTION

Accordingly, the aim of the present invention is to provide antitampering and safety ball valves devoid of the above mentioned drawbacks and disadvantages of the prior art ball valves, while having a simple construction and which, moreover, do not require any additional components or supplementary machining operations on the driving handle or other valve members.

Within the scope of the above mentioned aim, a main object of the present invention is to also exploit the teachings of the invention for valves having operating handles both of a squared type or of any other types, such as, for example, lever, wheel, throttle or the like handles, where, even in this case, the valve does not require any additional components or locking means for locking them, such as locks or padlocks.

According to the invention, the above mentioned aim and objects are achieved by an antitampering and safety ball valve having the features of claim 1.

Further features of the invention are indicated by the other claims.

The antitampering and safety ball valves according to the invention provide a lot of important advantages. At first, the feature of preventing any unauthorized removal of the clamping nut clamping the driving or rotary handle on the rod, without any auxiliary means, allows to use, for example, conventional squared configurations, i.e. without requiring any specifically designed machining operations or shapes, thereby holding the making costs practically unchanged. This is advantageously possible also due to the fact that for rendering the valve safe against unauthorized tamperings or removals of the driving handle thereof, it would be merely necessary to replace a conventional clamping nut, i.e. a nut having pairs of parallel sides, with a nut which does not include any opposite parallel side pairs. Moreover, by providing in the squared construction, a per se known cylindrical seat or recess of the clamping nut, however with only a small annular clearance allowing exclusively an application of a tubular wrench, it is prevented any possibilities that unauthorized persons could affect the nut by using conventional tools or different implements and/or random implements such as screwdrivers, blades and the like.

Yet another advantage is that the mentioned cylindrical seat or recess for housing the clamping nut for clamping the driving handle on the valve rod can be simply provided even on other types of driving or rotary handles, for example lever, wheel handles, throttle handles, which would merely require a small modifications of the handle making molds.

Yet another advantage is that the teachings of the invention can also be used both for metal valves and plastics material valves.

Yet another advantage of the invention is that it is possible to greatly reduce the stock inventory for the ball valve components since no additional novel components must be stored, with the exception of the inventive clamping nuts. Moreover, since, with the valve in an assembled condition, it would not be possible to visually detect any differences between the novel nuts and prior nuts, it would not be consequently possible to visually detect if the valve is a valve made according to the prior art or a valve made according to the teachings of the invention.

Yet another advantage is that conventional ball valves, and even already installed ball valves, for example on water or gas delivery systems, can be easily transformed into antitampering and/or safety ball valves according to the present invention.

### BRIEF DESCRIPTION OF THE DRAWINGS

Further advantages, details and characteristics of the ball valves according to the present invention will become more apparent hereinafter from the following disclosure with reference to the accompanying drawings, which illustrate, by an indicative example, two preferred embodiments of the invention.

In the drawings:

FIG. 1 is a general view of a ball valve according to the invention, with the squared handle thereof shown in a side elevation view, this figure also showing a top plan view of the squared handle and a recessed seat wrench for the inventive nut;

FIG. 2 is a longitudinal middle cross-sectional view, in exploded form, of the valve of FIG. 1;

FIG. 3 is a longitudinal cross-sectional view, like FIG. 2, of the assembled valve;

FIG. 4 is a side view of the valve shown in FIGS. 1-3;

FIG. 5 shows the detail A of FIG. 4, on an enlarged scale; and

FIG. 6 shows a partially cross-sectioned side view of a modified embodiment related to a throttle type of handle.

### DESCRIPTION OF THE PREFERRED EMBODIMENTS

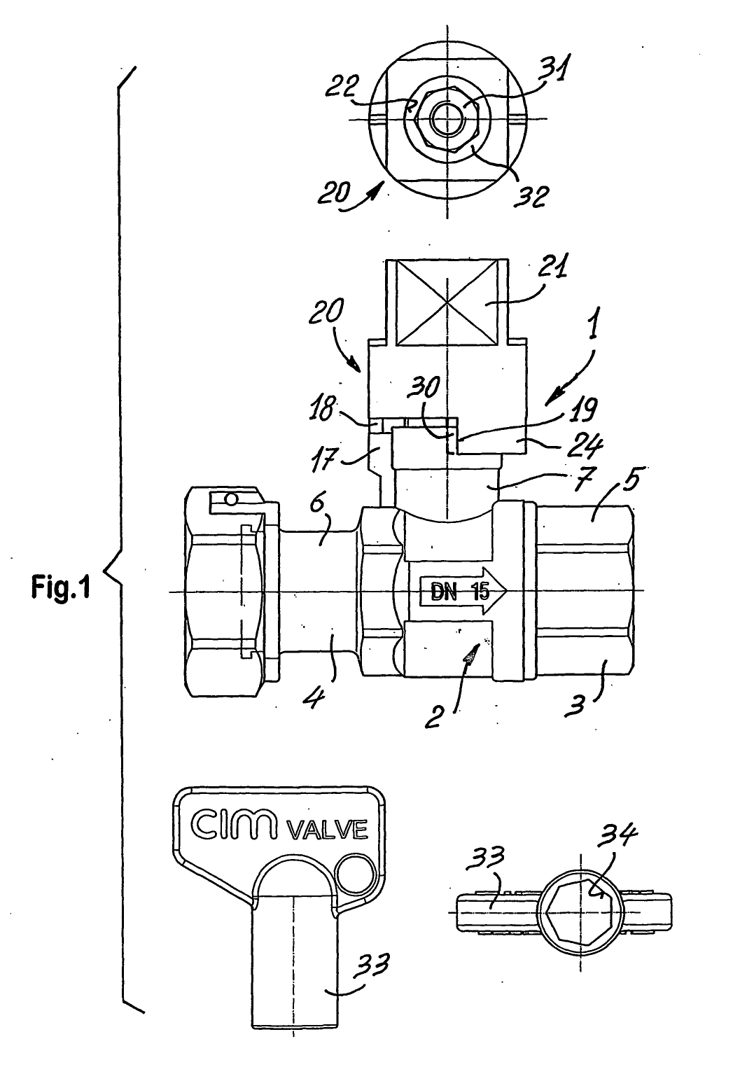

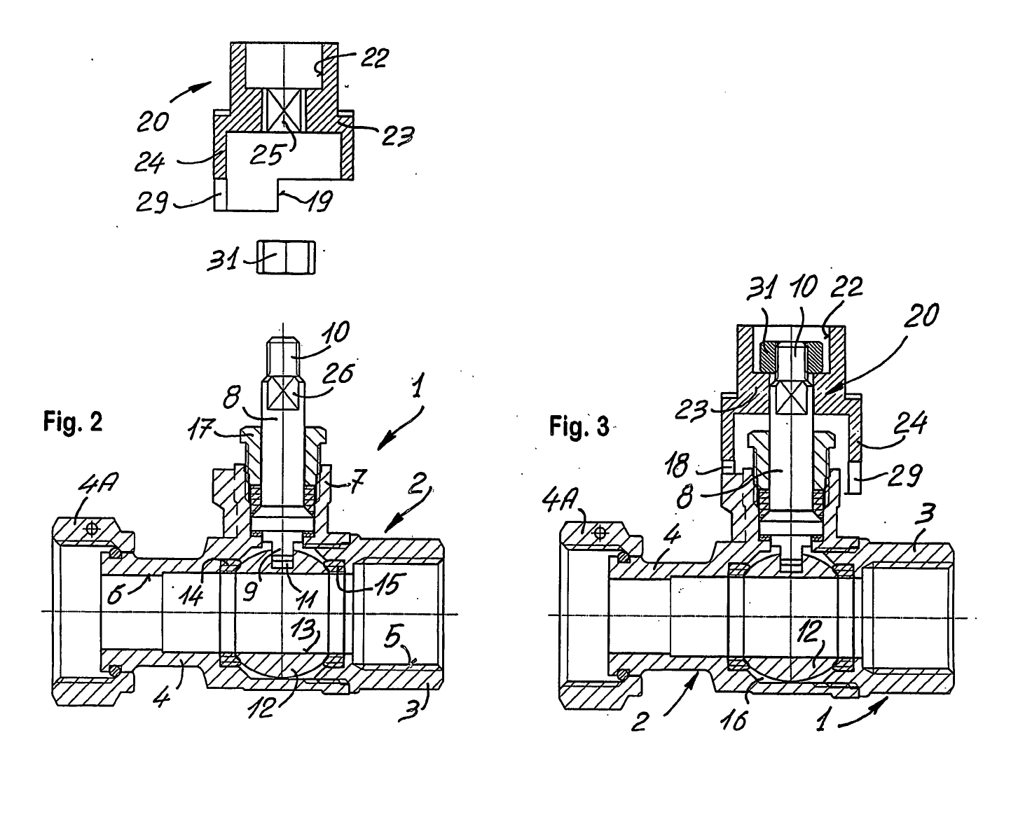

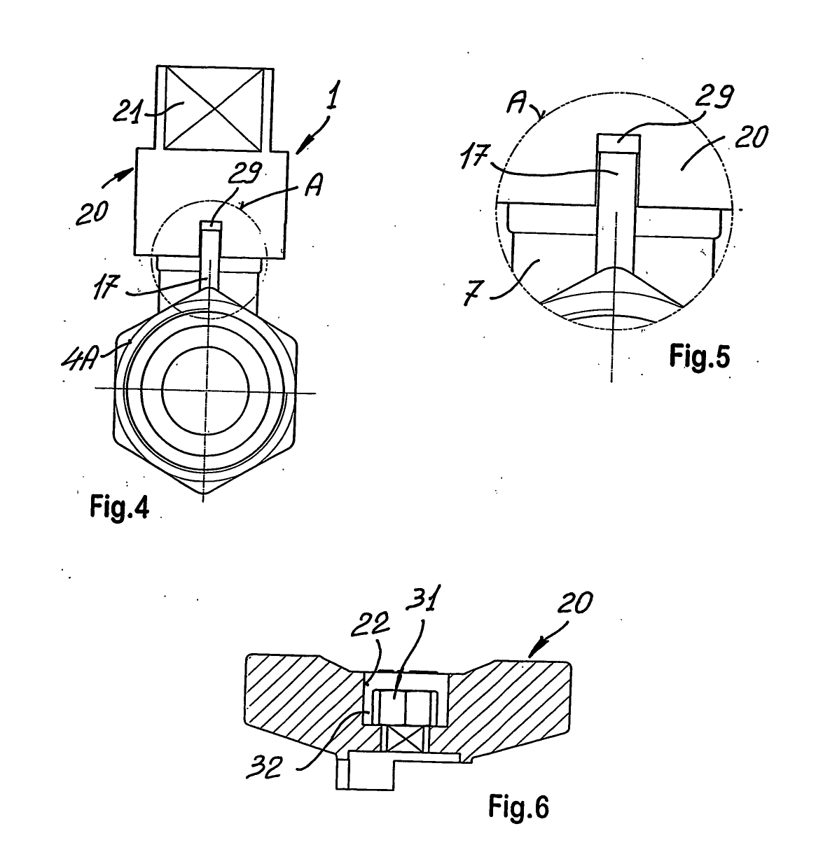

At first, it will be hereinbelow briefly disclosed the construction of a prior ball valve, generally indicated by the reference number 1 and comprising a valve body 2 formed, in the shown example, by two half-bodies 3 and 4, respectively, defining an inlet fitting 5 and an outlet fitting 6, or reversely, the reference 4A indicating a coupling sliding ring nut. The half-body 2 comprises moreover a collar 7, for tightly housing a rod 8 having an inner end 9 and an outer threaded end 10. The inner end 9 of the rod 8 is engaged, by a geometrical type of fixed coupling, in a seat or recess 11 of a ball shutter 12, having a throughgoing hole 13 and supported between two opposite gaskets 14 and 15 in a shutter housing chamber 16. The reference number 17 shows a lug of the valve body 2, having, for example, a strip shape, and providing an abutment cooperating with the two abutment sides 18 and 19 provided on the rotary or driving handle 20 for defining the required 90° rotary movement defining in turn the opening position and closing position of the ball shutter 12. In the example shown in FIGS. 1-5, the rotary or driving handle 20 comprises a so-called “squared member”, which substantially comprises a squared portion 21 (for applying thereon a shutter rotary wrench) with a cylindrical seat or recess 22, a bottom 23 and an underlying collar 24 having the above mentioned abutment sides 18 and 19. The reference number 25 shows a throughgoing seat, for example of quadrangular configuration, for coupling, by a geometrical type of connection, with a like quadrangular portion 26 formed on the rod 8. Finally, the reference numbers 29 and 30 show two seats formed in the collar 24 and adapted to engage on the strip abutment element 17 to lock the shutter 12 in an opening position or in the closing position thereof. The rotary or driving handle, or squared member 20, is clamped on the valve 1 by a conventional type of nut threaded on the projecting threaded portion 10 of the rod 8.

The above disclosure, as stated, relates to a conventional ball valve which, for the invention, is considered as representative for other prior types of ball valves, for example including a single piece valve body or a three-pieces valve body, with a rotary or driving handle formed as lever, wheel, throttle handle and so on, and with valve bodies including filter inserts, a telescopic end and so on.

At this point intervenes the invention, the teaching of which, for preventing any unauthorized removal of the handle 20, such as a squared handle 20, while allowing the shutter 12 to rotate through 90° from its opening position to its closing position (use of the ball valve as a safety valve) as well as to prevent an unauthorized removal of the rotary squared lever arranged in the locking position of the shutter in its closing position (use of the ball valve as an anti tampering valve), provides to use a clamping nut 31 having a perimeter which does not comprise any opposite parallel side pairs, either in a full or partial manner, and which, accordingly, does not allow a conventional wrench to be applied by a geometrical type of connection. This, according to the invention, can be obtained by using a clamping nut with a perimeter having an odd number of sides, for example, and preferably, in the form of an heptagon.

Moreover, according to the invention, to prevent the nut from being forcibly removed by using rod-like or blade-like articles, such as screwdrivers or the like, according to the invention, the inner diameter of the seat 22 housing the clamping nut 31 is larger than the circumference inscribing the clamping nut 31, so as to define an annular ring 32 of small thickness, or allowing, only with a small clearance, an application of a specifically designed tubular wrench 33 having a corresponding recessed seat 34 i.e., in the example, an heptagonal seat. By providing the above mentioned small thickness annular crown, it is practically prevented any engagements of tools or other forcing bodies for trying to unscrew or unthread the clamping nut 31.

This use combination, providing to use a nut having the is shape of a regular polygon having an odd number of sides, and an housing seat for said nut having a very small size, can be advantageously also used in other types of rotary handles 20, as stated, for example of a lever, a wheel, a throttle and so on type, provided that, in said handles, as shown by way of an example in FIG. 6, is provided a cylindrical-hollow seat 22, as disclosed above with reference to the embodiment shown in FIGS. 1-3.

Since also in the above mentioned rotary handles 20, having configurations different from prior squared handles, are provided both the abutment sides 18 and 19 and the recesses 29 and 30, for locking the rotary movement of the shutter 12 at an open or closed condition thereof, it should be apparent that also the above mentioned ball valves having any desired rotary handles can be used as safety and/or antitampering valves. The choice of using valves having rotary handles either of one or of the other type will depend, for example, on the considered system (for civil buildings, industrial systems, public systems and so on) and for restricted regions (for example in condominium block cellars, home outer systems or industrial buildings, or in free access areas, such as public parks, along sidewalks or surfaces accessible for pedestrians and so on).

In actual practice, it would be possible to also use nuts different from heptagonal nuts, for example pentagonal or triangular nuts, even if, with the latter, the seat 32 for housing the nut 31 would provide a slightly larger space for engaging therein screwdrivers and the like.

From the above constructional and operational disclosure, it should be apparent that the teachings of the present invention allow to efficiently achieve the above mentioned aim and object and the disclosed advantages.

In particular, it should be apparent that the teachings of the invention advantageously and simply allow to transform prior ball valves, in an already installed condition, into safety and/or antitampering ball valves according to the invention, by simply replacing their rotary handle (in the case of lever, wheel, throttle handles and the like) or, without replacing the handle, in the case of valves having a squared handle, and by merely replacing the conventional hexagonal clamping nut with a polygonal clamping nut having an odd number of sides, according to the invention, on which clamping nut, for example of heptagonal configuration, could not be applied conventional tubular wrenches having a squared or hexagonal recessed seat.

Accordingly, the scope of the invention, in addition to the antitampering and safety valves according to the invention, will also likewise include the rotary handles having a cylindrical-hollow seat and the clamping nuts of polygonal configuration with an odd number of sides, which handles and nuts can be considered individually as spare components for transforming prior ball valves, of any prior construction, into antitampering and safety ball valves, together with the related tubular wrenches with recessed seats of regular polygonal configuration with an odd number of sides.

In actual practice, one skilled in the art could suggest modifications and variations, for example combine at will features according to the invention, design novel configuration of handles and so on, without departing from the scope of the invention.

1. An antitampering and safety ball valve substantially comprising a valve body housing a ball shutter arranged between opposite gaskets and having an inlet fitting and an outlet fitting, and a collar rotatable tightly housing therein a rod which, at an inner end portion thereof, is engaged with a geometrical type of engagement in a seat of the ball shutter, said rod having an outer end portion including a contoured part and a threaded end engaging a clamping nut for clamping on said valve a rotary handle for rotatively driving through 90° said shutter, said handle having a contoured seat designed for engaging, with a geometrical type of engagement, with said contoured portion of said rod, said handle having preferably two seats designed for engaging on a lug of the valve body for locking said shutter at an opening or closing position thereof, characterized in that said ball valve comprises, in combination,
a) a clamping nut (31) for clamping said rotary handle (20), said clamping nut having a polygonal configuration with an odd side number, and
b) a cylindrical seat (32) for housing said clamping nut (31), said cylindrical seat being formed on said rotary handle (20) and having such a size as to define a small circular ring element (32) between said cylindrical seat (22) and clamping nut (31), allowing, preferably with a small clearance, a tubular wrench (33) having a recessed seat (34) and an odd number of sides corresponding to that of said clamping nut (31) to be applied.

2. A ball valve according to claim 1, characterized in that said odd side number clamping nut (31) for clamping said handle has a regular polygon configuration.

3. A clamping nut for clamping handles of ball valves, characterized in that said clamping nut has an heptagonal shape.

4. A handle for ball valve in the form of a lever, wheel, throttle element and the like, characterized in that said handle comprises a cylindrical seat (22) for housing, with a small clearance, a clamping nut (31) for clamping said handle (20) on an associated ball valve (1).

5. A handle for ball valves according to claim 4, characterized in that said handle houses a clamping nut having an odd number of sides.

6. A ball valve with a lever, wheel, throttle or the like handle, with a clamping nut for clamping said handle, which is freely accessible from outside, characterized in that said clamping nut (31) is a clamping nut according to claim 2.

7. A ball valve with a lever, wheel, throttle or the like handle, with a clamping nut for clamping said handle, which is freely accessible from outside, characterized in that said clamping nut (31) is a clamping nut according to claim 3.
